(19) United States
(12) Patent Application Publication
(10) Pub. No.: US 2008/0085455 A1
(43) Pub. Date: Apr. 10, 2008

(54) Methods for storing holographic data and storage media derived therefrom

(75) Inventors: Michael Jeffrey McLaughlin, Albany, NY (US); Christoph Georg Erben, Clifton Park, NY (US); Xiaolei Shi, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/545,162

(22) Filed: Oct. 10, 2006

(51) Int. Cl. G03H 1/04

(52) U.S. Cl. 430/1; 430/2; 369/3

(57) ABSTRACT

The present invention provides methods for storing holographic data and articles derived using these methods. The method includes providing an optically transparent substrate comprising a photochemically active dye and a sensitizing solvent. The method further includes irradiating the optically transparent substrate with a holographic interference pattern to form an optically readable datum and removing at least a portion of the sensitizing solvent from the optically transparent substrate to stabilize the optically readable datum.

### BACKGROUND

The invention relates generally to methods for storing holographic data and in particular to a holographic storage media and articles having an enhanced data storage lifetime derived using these methods.

Holographic storage is the storage of data in the form of holograms, which are images of three dimensional interference patterns created by the intersection of two beams of light, in a photosensitive medium. The superposition of the two beams of light, a signal beam, which contains digitally encoded data, and a reference beam forms an interference-pattern within the volume of the medium resulting in a chemical reaction that changes or modulates the refractive index of the medium. This modulation serves to record as hologram both the intensity and phase information from the signal beam. The hologram can later be retrieved by exposing the storage medium to the reference beam alone, which interacts with the stored holographic data to generate a reconstructed signal beam proportional to the initial signal beam used to store the holographic image. Thus, in holographic data storage, data is stored throughout the volume of the medium via three dimensional interference patterns.

Each hologram may contain anywhere from one to 1×10⁶ or more bits of data. One distinct advantage of holographic storage over surface-based storage formats, including compact discs (CD) or digital video discs (DVD), is that a large number of holograms may be stored in an overlapping manner in the same volume of the photosensitive medium using a multiplexing technique, such as by varying the signal and/or reference beam angle, wavelength, or medium position. However, a major impediment towards the realization of holographic storage as a viable technique has been the development of a reliable and economically feasible storage medium.

Early holographic storage media employed inorganic photo-refractive crystals, such as doped or un-doped lithium niobate (LiNbO₃), in which incident light creates refractive index changes. These refractive index changes are due to the photo-induced creation and subsequent trapping of electrons leading to an induced internal electric field that ultimately modifies the refractive index through a linear electro-optic effect. However, LiNbO₃ is expensive, exhibits relatively poor efficiency, fades over time, and requires thick crystals to observe any significant index changes.

More recent work has led to the development of polymers doped with dye that can sustain large index changes on optical absorption of the dye. The sensitivity of a dye-doped data storage material is dependent upon the concentration of the dye, the dye's absorption cross-section at the recording wavelength, the quantum efficiency of the photochemical transition, and the index change of the dye molecule for a unit dye density. However, as the product of dye concentration and the absorption cross-section increases, the disc becomes opaque, which complicates both recording and readout. Moreover, polymers doped with dyes are sensitive to light even after the writing step.

Therefore, it is desirable to develop improved methods for holographic data storage and materials through which enhanced holographic data storage capacities can be achieved. Further, it is also desirable to enhance the lifetime of the stored holographic data, such that, for example, the data is not erased thermally, or when ambient light is incident on the data storage medium, or during read-out.

### BRIEF DESCRIPTION

Disclosed herein are methods for storing holographic data in a storage medium having an enhanced data storage lifetime, and articles made using these methods.

In one embodiment, the present invention provides for storing holographic data, said method comprising:

providing a holographic storage medium comprising an optically transparent substrate, said optically transparent substrate comprising a photochemically active dye and a sensitizing solvent;

step (A) irradiating the optically transparent substrate with a holographic interference pattern, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing an optically readable datum corresponding to the volume element; and

step (B) removing at least a portion of the sensitizing solvent from the optically transparent substrate to stabilize the optically readable datum.

In another embodiment, the present invention provides for storing holographic data, said method comprising:

providing a holographic storage medium comprising an optically transparent substrate, said optically transparent substrate comprising a photochemically active dye and a sensitizing solvent, wherein the photochemically active dye comprises a nitrostilbene, and wherein the sensitizing solvent comprises acetonitrile;

step (A) irradiating the optically transparent substrate with a holographic interference pattern, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing an optically readable datum corresponding to the volume element; and

step (B) removing at least a portion of the sensitizing solvent from the optically transparent substrate to stabilize the optically readable datum.

In yet another embodiment, the present invention provides for storing holographic data, said method comprising:

Providing a holographic storage medium comprising an optically transparent substrate, said optically transparent substrate comprising a photochemically active dye and a sensitizing solvent, wherein the photochemically active dye comprises 4-hydroxy-2′,4′-dinitrostilbene, wherein the dye is present in an amount from about 0.1 weight percent to about 10 weight percent, wherein the sensitizing solvent comprises acetonitrile;

step (A) irradiating the optically transparent substrate with a holographic interference pattern, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing an optically readable datum corresponding to the volume element, wherein the first wavelength is about 532 nm; and

step (B) removing at least a portion of the sensitizing solvent from the optically transparent substrate to stabilize the optically readable datum.

In still yet another embodiment, the present invention provides a data storage medium prepared using the above methods.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a holographic data storage system during writing in one embodiment of the present invention;

FIG. 2 is a schematic representation of a holographic data storage system during read-out in one embodiment of the present invention; and

FIG. 3 is a plot of change in absorbance with time of a 4-hydroxy-2′,4′-dinitrostilbene dye in poly (methyl methacrylate) upon exposure to 532 nanometer and recorded at 500 nanometer; the dotted curve shows the change in absorbance in the absence of a sensitizing solvent, and the solid curve shows the change in absorbance in the presence of a sensitizing solvent.

### DETAILED DESCRIPTION

As defined herein, the term “optically transparent” as applied to an optically transparent substrate or an optically transparent plastic material means that the substrate or plastic material has an absorbance of less than 1. That is, at least 10 percent of incident light is transmitted through the material at at least one wavelength in a range between about 300 nanometers and about 1500 nanometers. For example, when configured as a film having a thickness suitable for use in holographic data storage said film exhibits an absorbance of less than 1 at at least one wavelength in a range between about 300 nanometers and about 1500 nanometers.

As defined herein, the term “volume element” means a three dimensional portion of a total volume.

As defined herein, the term “optically readable datum” can be understood as a datum that is stored as a hologram patterned within one or more volume elements of an optically transparent substrate.

As used herein, the term “enhanced lifetime” refers to an enhanced data robustness. For example, an optically readable datum stabilized according to the method of the present invention can be subjected to an increased number of read-out cycles of the optically readable datum without performance degradation relative to the corresponding unstabilized optically readable datum.

As defined herein, absorption cross section is a measurement of an atom or molecule's ability to absorb light at a specified wavelength, and is measured in square cm/molecule. It is generally denoted by σ(λ) and is governed by the Beer-Lambert Law for optically thin samples as shown in Equation (1),

$$σ ( λ ) = ln ( 10 ) \cdot \frac{Absorbance ( λ )}{{N}_{o} \cdot L} ( {cm}^{2} ) \qquad Equation ( 1 )$$

wherein N₀ is the concentration in molecules per cubic centimeter, and L is the sample thickness in centimeters.

As defined herein, quantum efficiency (QE) is a measure of the probability of a photochemical transition for each absorbed photon of a given wavelength. Thus, it gives a measure of the efficiency with which incident light is used to achieve a given photochemical conversion. QE is given by equation (2),

$$QE = \frac{hc / λ}{σ \cdot {F}_{0}} \qquad Equation ( 2 )$$

wherein “h” is the Planck's constant, “c” is the velocity of light, σ(λ) is the absorption cross section at the wavelength λ, and F₀ is the bleaching fluence. The parameter F₀ is given by the product of light intensity (I) and a time constant (τ) that characterizes the bleaching process.

As noted, holographic data storage relies upon the introduction of localized variations in the refractive index of the optically transparent substrate comprising the photochemically active dye as a means of storing holograms. The refractive index within an individual volume element of the optically transparent substrate may be constant throughout the volume element, as in the case of a volume element that has not been exposed to electromagnetic radiation, or in the case of a volume element in which the photochemically active dye has been reacted to the same degree throughout the volume element. It is believed that most volume elements that have been exposed to electromagnetic radiation during the holographic data writing process will contain a complex holographic pattern, and as such, the refractive index within the volume element will vary across the volume element. In instances in which the refractive index within the volume element varies across the volume element, it is convenient to regard the volume element as having an “average refractive index” which may be compared to the refractive index of the corresponding volume element prior to irradiation. Thus, in one embodiment an optically readable datum comprises at least one volume element having a refractive index that is different from a (the) corresponding volume element of the optically transparent substrate prior to irradiation. Data storage is achieved by locally changing the refractive index of the data storage medium in a graded fashion (continuous sinusoidal variations), rather than discrete steps, and then using the induced changes as diffractive optical elements.

In one embodiment of the invention, a holographic storage medium comprising an optically transparent substrate is provided. The optically transparent substrate may be made of materials possessing sufficient optical quality such as, low scatter, low birefringence, and negligible losses at the wavelengths of interest, to render the data stored in the holographic storage medium readable. Generally, plastic materials that exhibit these properties may be used as the substrate. However, the plastic materials should be capable of withstanding the processing parameters (e.g., inclusion of the dye, exposure to a sensitizing solvent and application of any coating or subsequent layers, and molding it into a final format) and subsequent storage conditions. In one embodiment, the optically transparent plastic materials may comprise organic polymers such as, for example, oligomers, polymers, dendrimers, ionomers, copolymers such as block copolymers, random copolymers, graft copolymers, star block copolymers, and the like, or a combination comprising at least one of the foregoing polymers.

Further, the optically transparent plastic material may comprise a thermoplastic polymer, a thermosetting polymer, or a combination comprising at least one of the foregoing polymers. Non-limiting examples of thermoplastic polymers include polyacrylates, polymethacrylates, polyamides, polyolefins, polycarbonates, polystyrenes, polyesters, polyamideimides, polyaromaticsulfones, polyethersulfones, polyphenylene sulfides, polysulfones, polyimides, polyetherimides, polyetherketones, polyether etherketones, polyether ketone ketones, polysiloxanes, polyurethanes, polyaromaticene ethers, polyethers, polyether amides, polyether esters, or the like, or a combination comprising at least one of the foregoing thermoplastic polymers. Other examples of thermoplastic polymers include, but are not limited to, amorphous and semi-crystalline thermoplastic polymers and polymer blends, such as, polyvinyl chloride, linear and cyclic polyolefins, chlorinated polyethylene, polypropylene, and the like; hydrogenated polysulfones, acrylonitrile butadiene styrene (ABS) resins, hydrogenated polystyrenes, syndiotactic and atactic polystyrenes, polycyclohexyl ethylene, styrene-acrylonitrile copolymer, styrene-maleic anhydride copolymer, and the like; polybutadiene, poly (methyl methacrylate) (PMMA), methyl methacrylate-polyimide copolymers; polyacrylonitrile, polyacetals, polyphenylene ethers, including, but not limited to, those derived from 2,6-dimethylphenol and copolymers with 2,3,6-trimethylphenol, and the like; ethylene-vinyl acetate copolymers, polyvinyl acetate, ethylene-tetrafluoroethylene copolymer, aromatic polyesters, polyvinyl fluoride, polyvinylidene fluoride, and polyvinylidene chloride. In some embodiments, the thermoplastic polymers used in the holographic storage medium is made of a polycarbonate. The polycarbonate may be an aromatic polycarbonate, an aliphatic polycarbonate, or a polycarbonate comprising both aromatic and aliphatic structural units. One example of a suitable polycarbonate is Lexan®, commercially available from General Electric Company.

Non-limiting examples of thermosetting polymers include those selected from the group consisting of an epoxy polymer, a phenolic polymer, a polysiloxane, a polyester, a polyurethane, a polyamide, a polyacrylate, a polymethacrylate, or a combination comprising at least one of the foregoing thermosetting polymers.

The optically transparent substrate may have a thickness depending on the intended usage of the storage medium. In one embodiment, the thickness of the storage medium is greater than about 100 micrometers. In some embodiments, the thickness may vary from about 100 micrometers to about 5 centimeters. For example, for use as a DVD or CD storage device typical thickness is about 600 micrometers to about 1.2 millimeters. The shape of the optically transparent substrate includes a variety of shapes such as, but not limited to, a square, a rectangle, an oval or a circular shape.

As noted above, a photochemically active dye is disposed on the optically transparent substrate. The photochemically active dye is one, which renders the optically transparent substrate capable of having holograms “written” into it at a first wavelength. And further, the photochemically active dye should be such that a hologram having been “written” into the optically transparent substrate at a first wavelength is not erased when the hologram is “read”. It is desirable to use dyes that enable “writing” of the holographic interference pattern into the optically transparent substrate at the first wavelength, which is in a range from about 360 nanometers (nm) to about 1500 nm. In some embodiments, the first wavelength is in a range from about 400 nm to about 650 nm. Exemplary first wavelengths are about 405 nm and about 532 nm. The first wavelength is also sometimes referred to as the “write” wavelength at which the hologram is written in the optically transparent substrate.

In one embodiment, the photochemically active dye is disposed in the optically transparent substrate along with a sensitizing solvent. The sensitizing solvent enhances the sensitivity of the photochemically active dye towards the first wavelength of light. In one embodiment, due to the enhancement in the sensitivity of the photochemically active dye, the writing process occurs at lower fluence as compared to when there is no sensitizing solvent present. In yet another embodiment, the sensitizing solvent is removed after the writing process so as to reduce the sensitivity of the photochemically active dye towards the first wavelength of light. This may advantageously increase the number of read-out cycles without the destruction of the written hologram.

In one embodiment, the photochemically active dye (sometimes referred to as the dye) utilized in the present invention is preferably organic dyes with narrow absorption band, which undergo a chemical change upon exposure to certain “write” wavelengths of light. The photochemically active narrow band dye is defined as having an absorption spectrum which is characterized by a center wavelength associated with the maximum absorption and a spectral width (full width at half of the maximum, FWHM) of less than about 500 nanometers. The photo-product or photo-products which result from interaction of the photochemically active dye with light having the “write” wavelength typically exhibits an absorption spectrum which is entirely different from that exhibited by the dye prior to irradiation. The chemical change in the dye produced by interaction with light of the write wavelength produces a corresponding change in the molecular structure of the dye, thereby producing a “photo-product”. This modification to the structure of the dye molecule and concurrent changes in the light absorption properties of the photo-product(s) relative to the starting dye produces a significant change in refractive index within the substrate that can be observed at a “read” wavelength.

Non-limiting examples of the photochemically active dye include a nitrostilbene, a nitrone, a diarylethene, or a fulgide. In one embodiment, the organic dye utilized is a nitrostilbene or a nitrostilbene derivative. It is desirable, that one of the aromatic rings of the nitrostilbene dye molecule has a nitro group ortho to the double bond connecting the two phenyl rings of the nitrostilbene. Examples of nitrostilbenes include, but are not limited to, 4-dimethylamino-2′,4′-dinitrostilbene, 4-(1-morpholino)-2′,4′-dinitro-stilbene, 4-(1-piperidino)-2′,4′-dinitrostilbene, 4-hydroxy-2′,4′-dinitro-stilbene, 4-phenoxy-2′,4′-dinitrostilbene, 2,4-dinitrostilbene, and the like. Nitrone dyes are illustrated by α-aryl-N-arylnitrones and conjugated analogs thereof in which the conjugation is between the aryl group and an α-carbon atom. The α-aryl group is frequently substituted, often by a dialkylamino group, in which the alkyl groups contain 1 to about 4 carbon atoms. Non-limiting examples of nitrones include α-(4-diethylaminophenyl)-N-phenylnitrone, α-(4-diethylaminophenyl)-N-(4-chlorophenyl)-nitrone, α-(4-diethylaminophenyl)-N-(3,4-dichlorophenyl)-nitrone, α-(4-diethylaminophenyl)-N-(4-carbethoxyphenyl)-nitrone, α-(4-diethylaminophenyl)-N-(4-acetylphenyl)-nitrone, α-(4-dimethylaminophenyl)-N-(4-cyanophenyl)-nitrone, α-(4-methoxyphenyl)-N-(4-cyanophenyl)nitrone, α-(9-julolidinyl)-N-phenylnitrone, α-(9-julolidinyl)-N-(4-chlorophenyl)nitrone, α-(4-dimethylamino)styryl-N-phenyl nitrone, α-Styryl-N-phenyl nitrones, α-[2-(1,1-diphenylethenyl)]-N-phenylnitrone, α-[2-(1-phenylpropenyl)]-N-phenylnitrone, or a combination comprising at least one of the foregoing nitrones. Non-limiting examples of diarylethenes include diarylperfluorocyclopentenes, diarylmaleic anhydrides, diarylmaleimides, or a combination comprising at least one of the foregoing diarylethenes. Non-limiting examples of fulgides include (E)-2,5-dimethyl-3-furylethylidene(methyl methylene)succinic anhydride, (E)-(2,5-dimethyl-3-furylethylidene) (isopropylidene) succinic anhydride), 2-(1-(2,5-dimethyl-3-furyl)ethylidene)-3-(2-adamantylidene)succinic anhydride, or a combination comprising at least one of the foregoing fulgides.

In some embodiments, the photochemically active dye may form part of a guest-host system wherein the photochemically active dye is the guest and the substrate is the host. In some embodiments, the photochemically active dye is dissolved in a solvent together with the polymer host to produce a solution. Films can be made by spin-coating from this solution. In other embodiments, films can be formed by blade coating, substrate dipping, and spraying the dye/polymer solution. Suitable polymeric substrate materials containing the photochemically active dye are at times referred to as “doped polymers”. Such doped polymers can be prepared by a variety of techniques such as the solvent casting technique referred to above. In one embodiment, the doped polymers can also be formed by dissolving the photochemically active dye in a liquid monomer and therafter thermally or photoreactively polymerizing the monomer in the presence of the photochemically active dye to produce an optically transparent substrate material having dispersed uniformly within it the photochemically active dye. In another embodiment, such doped polymers is prepared by molding or extrusion techniques of polymer/dye blends.

In some embodiments, the photochemically active dye may be chemically bound to a polymer support. Attachment of the dye to the polymer support may be accomplished by including reactive substituents on the dye molecule that participate in a polymerization reaction. Suitable substituents include simple alcohols, amines, carboxylates, and other reactive functional groups, such as chloroformates. The product polymers comprise the photochemically active dye which is appended to the polymer. The photochemically active dye may be incorporated into the backbone of the polymer chain, or attached to the polymer chain as a chain stopper. Suitable polymers include, for example, bisphenol, polycarbonate, polyetherimides, acrylate polymers such as PMMA, polysulfones, polyamides, and the like. Where utilized, films and discs can be formed using methods described above for guest-host systems.

In one embodiment, the photochemically active dye is disposed in the substrate in an amount from about 0.1 weight percent to about 20 weight percent. In some embodiments, the photochemically active dye is present in an amount from about 5 weight percent to about 10 weight percent in the substrate. In yet another embodiment, the photochemically active dye is present in the substrate in an amount from about 15 weight percent to about 20 weight percent. As used herein, the term “weight percent” of the dye refers to a ratio of the weight of the dye included in the substrate to the total weight of the substrate (inclusive of the weight of the dye). For example, 10 weight percent of the dye disposed in a substrate implies 10 grams of the dye in 90 grams of the substrate. The loading percentage of the dye may be controlled to provide desirable properties.

The sensitizing solvent, as noted above, is included in the optically transparent substrate. In one embodiment, on introduction of the sensitizing solvent to the substrate, there is a shift in the absorption spectrum of the photochemically active dye due to well-understood solvent effects. The solvent effects may cause a decrease in absorbance at the first wavelength due to the shift in the absorption spectrum of the photochemically active dye. In addition, the sensitizing solvent may facilitate the photo-induced reaction of the photochemically active dye on exposure to radiation of the first wavelength. The sensitizing solvent is chosen such that the photo-induced reaction rate of the dye is enhanced as compared to the photo-induced reaction rate of the photochemically active dye without the solvent. According to embodiments of the invention, a ratio of the photo-induced reaction rate of the photochemically active dye exposed to the sensitizing solvent to that of the photo-induced reaction rate of the photochemically active dye not exposed to the sensitizing solvent is at least about 1:1.1. Typical photo-induced reaction of the dye includes, but are not limited to, photo-decomposition reaction, including photo-bleaching due to oxidation, reduction, or bond breaking to form smaller constituents, or a molecular rearrangement, such as a sigmatropic rearrangement, or addition reactions including pericyclic cycloadditions. In one embodiment, the dye that is exposed to the solvent decreases in absorbance much faster than the dye that is not exposed to the solvent upon irradiation at a wavelength that may correspond to the “write” wavelength of the medium. The decrease in absorbance is otherwise termed as “photo-bleaching”. The photo-bleaching of the dye may be explained in terms of the formation of the photo-product which exhibits a different absorption band than that of the parent dye. The dye, in one embodiment, undergoes accelerated photo-bleaching reaction at the write wavelength on exposure to sensitizing solvent to form an irreversible photo-product.

Example sensitizing solvents include solvents compatible with the substrate such as, toluene, water, methyl ethylketones, alcohols, ethers, acetone, ammonia, acetylacetone, or a mixture comprising one or more of the foregoing solvents. For example, a substrate comprising polycarbonate is not compatible with solvents like acetone and hence solvents such as, petroleum ether, or alcohol may be used. The sensitizing solvent is present in an amount sufficient enough to saturate the dye. As used herein, the term “saturate the dye” refers to about 80 percent of the dye in the substrate that is in contact with the solvent and which may facilitate the photo-induced reaction of the dye. In one embodiment, the substrate including the dye is exposed to solvent for a time period greater than about 1 minute so as to saturate the dye. In some embodiments, the substrate including the dye is exposed to solvent for a time period in a range from about 1 hour to about 3 hours. In certain embodiments, the time period is greater than about 3 hours. Further, by controlling pressure, temperature or a combination of both, the exposure time of the solvent may be varied to obtain the saturation of the dye.

In one embodiment, the sensitizing solvent is supplied in the form of solvent vapor or solvent vapor forming material along with the substrate having the photochemically active dye. For example, ammonia may be provided as ammonium chloride which due to its low vapor pressure easily gives out ammonia vapor at normal atmospheric pressure. The ammonium chloride may be exposed to the substrate so as to saturate the dye.

Moreover, the photochemically active dye and the sensitizing solvent may be admixed with other additives to form a photo-active material. Examples of such additives include heat stabilizers, antioxidants, light stabilizers, plasticizers, antistatic agents, mold releasing agents, additional resins, binders, blowing agents, and the like, as well as combinations of the foregoing additives. The photo-active materials are used for manufacturing holographic data storage media. Cycloaliphatic and aromatic polyesters can be used as binders for preparing the photo-active material. These are suitable for use with thermoplastic polymers, such as polycarbonates, to form the optically transparent substrate. These polyesters are optically transparent, and have improved weatherability, low water absorption and good melt compatibility with the polycarbonate matrix.

The holographic storage media provided by the present invention may be produced utilizing methods of the present disclosure. In one embodiment, the method includes providing a holographic storage medium comprising an optically transparent substrate comprising a photochemically active dye and a sensitizing solvent. The optically transparent substrate may be produced in a conventional reaction vessel capable of adequately mixing various precursors, such as a single or twin screw extruder, kneader, blender, or the like. The precursors include polymer precursors and optionally the photochemically active dye. The optically transparent substrate thus formed may be exposed to the sensitizing solvent so as to saturate the dye.

It is to be appreciated, that the optically transparent substrate including the photochemically active dye and the sensitizing solvent should be capable of withstanding the processing conditions used to prepare the holographic storage medium. For example, such processing conditions may include polymer formation steps and further processing to form the final product.

Typically, the extruder should be maintained at a sufficiently high temperature to melt the precursors without causing decomposition thereof. For polycarbonate, for example, temperatures of about 220° C. to about 360° C. can be used, with about 260° C. to about 320° C. preferred. Similarly, the residence time in the extruder should be controlled to minimize decomposition. Residence times of up to about 2 minutes (min) or more can be employed, with up to about 1.5 min preferred, and up to about 1 min especially preferred. Prior to extrusion into the desired form (typically pellets, sheet, web, or the like, the mixture can optionally be filtered, such as by melt filtering and/or the use of a screen pack, or the like, to remove undesirable contaminants or decomposition products. Once the composition of the optically transparent substrate has been produced, it can be formed into the substrate using various molding and/or processing techniques. Possible techniques include injection molding, film casting, extrusion, press molding, blow molding, stamping, and the like.

As noted above, the holographic storage media provided by the present invention comprise an optically transparent substrate having a dye material and sensitizing solvent distributed evenly throughout the optically transparent substrate which forms the basis for data storage. Preferably, the dye exhibits a narrowband absorption spectrum. In addition, suitable dyes undergo accelerated photo-induced reactions in the presence of the sensitizing solvent that significantly alter their absorption characteristics. Thus, the dye materials utilized in accordance with the present invention allow for increased refractive index changes due to the refractive index dispersion associated with the photo-induced changes in the narrowband absorption dye.

In step A, of the method of the present invention the optically transparent substrate is irradiated with a holographic interference pattern, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing an optically readable datum corresponding to the volume element. Thus in one embodiment, data storage in the form of holograms is achieved wherein the photo-product is patterned (for example, in a graded fashion) within the optically transparent substrate to provide the at least one optically readable datum.

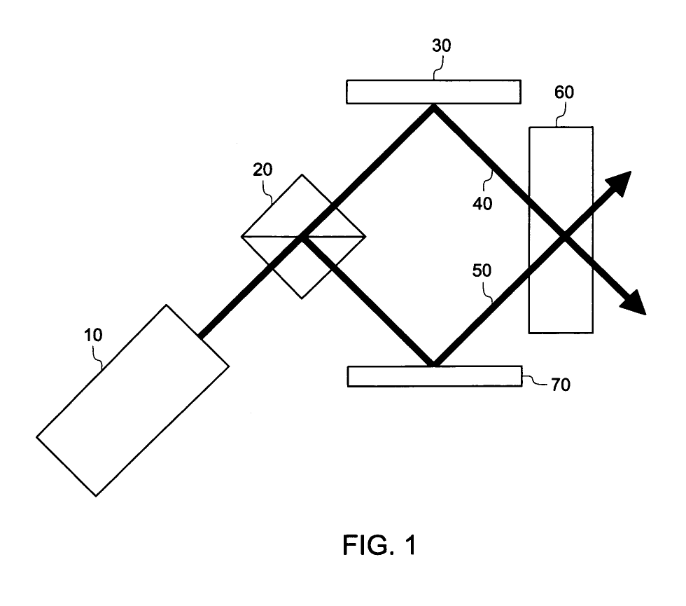

An example of a holographic data storage process according to the method of the present invention is shown in FIG. 1. Holographic data is stored within a holographic storage medium 60 of the present invention, wherein holographic storage medium 60 comprises an optically transparent substrate, said optically transparent substrate comprising a photochemically active dye and a sensitizing solvent. In FIG. 1 the output from a laser 10 (532 nm) is divided into two equal beams by a beam splitter 20. One beam, the signal beam 40, is incident on some form of a spatial light modulator (SLM) or deformable mirror device (DMD) 30, which imposes the data to be stored on the signal beam 40. This device is composed of a number of pixels that can block or transmit the light based upon input electrical signals. Each pixel can represent a bit or a part of a bit (a single bit may consume more than one pixel of the SLM or DMD) of data to be stored. The output of the SLM or DMD 30 is then incident on a storage medium 60. The second beam, the reference beam 50, is transmitted all the way to the storage medium 60 by reflection off mirror 70 with minimal distortion. The two beams are coincident on the same area of the storage medium 60 at different angles. The net result is that the two beams create an interference pattern at their intersection in the medium 60. The interference pattern is a unique function of the data imparted to the signal beam 40 by the SLM or DMD 30. The dye material within the holographic storage media undergoes a chemical change that results in a change in the refractive index of the region exposed to the laser light, and consequently the interference pattern that is created is “fixed” within the holographic storage medium, effectively creating an optically readable datum in the storage medium 60.

The methods disclosed herein can be used for producing holographic data storage media that can be used for bit-wise type data storage in one embodiment, and page-wise type storage of data in another embodiment. In still another embodiment, the methods can be used for storing data in multiple layers of the data storage medium.

The optically readable datum thus created has to be stabilized such that there is no loss of data due to the decomposition of the optically readable datum with time. One way of fixing the optically readable datum is by fixing the dye and the photo-product such that there is no change in the structure of the dye and the photo-product. In step B of the method of the present invention, at least a portion of the sensitizing solvent is removed from the optically transparent substrate to stabilize the optically readable datum. The removal of the sensitizing solvent inhibits further changes to the dye and the photo-product(s). In one embodiment, the sensitizing solvent is removed by exposing the storage medium to air or an open environment so that any residual solvent present evaporates to the environment. In the method as disclosed above, the storage medium is stabilized at the write wavelength and advantageously this removes the necessity of irradiation with a second wavelength to stabilize the optically readable datum.

The optically readable datum thus created is readable. In one embodiment, the read wavelength is the same as the write wavelength. The refractive index change created by using a laser wavelength that is strongly absorbed by the dye is advantageously utilized to write the hologram. The absorption of this light induces a photochemical reaction that irreversibly converts the dye molecules from one compound to a second compound or a set of compounds. The product of the reaction does not have the strong absorption at the laser wavelength that characterized the initial dye. However, because the interference pattern is composed of bright and dark regions, some of the dye is unexposed and needs to remain unexposed to maintain successful operation. The reading wavelength is chosen so that it still falls within the spectral region where the refractive index change is present, but outside the region of strong absorption.

In constructing the holographic storage media of the present disclosure, one can select a dye material and a wavelength of light that would result in a desired absorption at the wavelength of light being used. In some embodiments, the write wavelength band can be any part of the spectrum where not more than 90% of the incident light is absorbed. However, having too strong an absorption can cause nonlinearities in the storage of the data leading to poor reconstruction of the stored information. In addition, reducing the absorption can be accomplished by lowering the concentration of dye material in the substrate, this has the disadvantage of reducing maximum achievable refractive index change and subsequently reducing the efficiency of the material in storing the data. Furthermore, having too little absorption results in a lack of sensitivity and the material requires long exposure times to store data.

An alternative to enhance data storage efficiency is to alter the system so that the wavelength for writing does not coincide with the maximum absorption of the dye material. This allows one to add substantially more dye into the holographic storage medium but still maintain a manageable absorption coefficient such that the data is accurately stored. The proper amount can be determined as a function of the maximum absorption of the dye. For example, if the peak absorption is such that only 1% of the light at the same wavelength is a transmitted, the write wavelength can be chosen away from the peak such that the material transmits from about 25% to about 75% of the incident light. In some cases, the transmission can range from about 40% to about 60%, with a transmission of about 50% present in some other embodiments.

As one skilled in the art will appreciate, different molecules will have widely differing absorption profiles (broader, narrower, etc.). Thus, the wavelengths utilized for writing and reading the holographic storage media of the present disclosure will depend upon the light source, the substrate, and the dye material. Wavelengths suitable for writing data into the holographic storage media can vary depending upon both the substrate and dye material used, and can range from about 360 nm to about 1500 nm, preferably from about 400 nm to about 650 nm.

In some embodiments, the read wavelengths are different from the write wavelength, such that at the wavelength selected for reading the information contained in the holographic storage medium there is very little or no absorption of the reading light. Preferably the wavelength of light employed for reading is selected such that the difference between the reading wavelength and the absorption band associated with the writing event is maximized. In one embodiment the read beam has a wavelength shifted from about 50 nm to about 400 nm from the write beam's wavelength. In some embodiments, a suitable read beam has a wavelength from about 400 nm to about 800 nm. However, the farther away from the absorption band, the smaller the refractive index change, which negatively impacts the efficiency of the storage process. In addition, the greater the separation between the writing and reading wavelengths, the more difficult it may be to reconstruct the data. Thus, in some embodiments, reading wavelengths are most preferably selected as the nearest wavelength where the transmission is greater than 95%.

In some embodiments, blue light at wavelengths ranging from about 375 nm to about 425 nm may be used for writing and green/red light at wavelengths ranging from about 500 nm to about 800 nm may be used for reading. In other embodiments, the wavelength of light used for writing can range from about 425 nm to about 550 nm, and the reading wavelength can range from about 600 nm to about 700 nm. In one embodiment, a wavelength of 532 nm light can be used for writing and wavelengths of either 633 nm or 650 nm light can be used for reading.

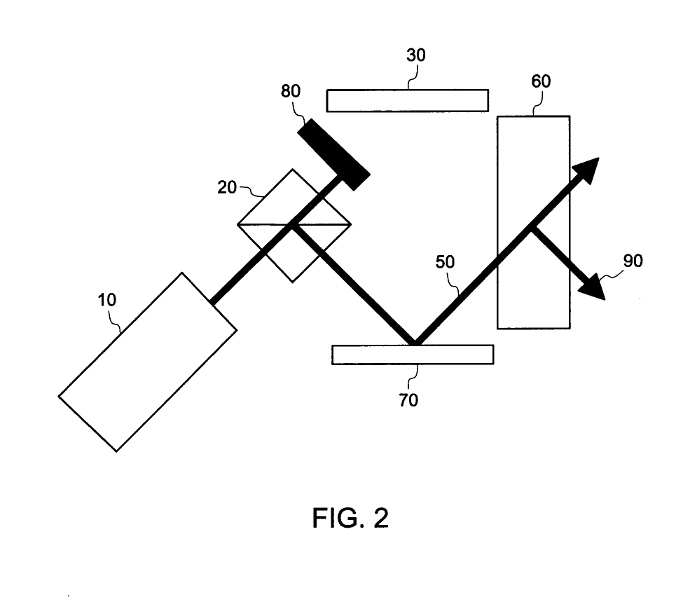

For reading the data, as depicted in FIG. 2, the pattern created in the storage medium 60 is simply exposed to the reference beam 50 in the absence of the signal beam by blocking the signal beam with a shutter 80 and the data is reconstructed in a reconstructed signal beam 90.

Without further elaboration, it is believed that one skilled in the art can, using the description herein, utilize the present invention to its fullest extent. The following example is included to provide additional guidance to those skilled in the art in practicing the claimed invention. The example provided is merely representative of the work that contributes to the teaching of the present application. Accordingly, the example is not intended to limit the invention, as defined in the appended claims, in any manner.

### EXAMPLE 1

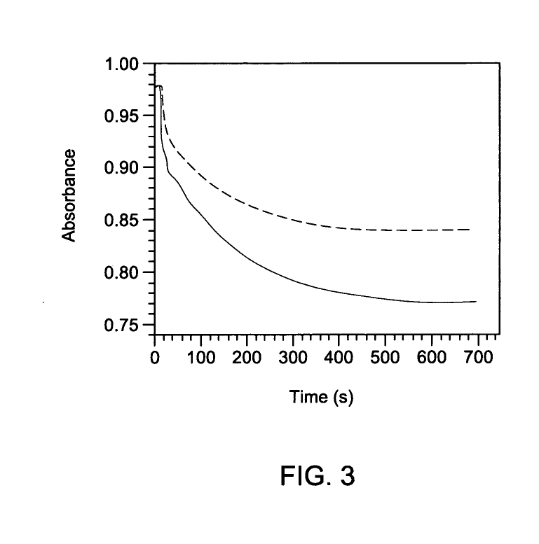

A thin film (about 0.10 mm thick) of PMMA containing 3 weight percent of 4-hydroxy-2′,4′-dinitrostilbene was solvent cast from a 10% solution of dichloromethane. After drying it overnight, the film was cut into 2 pieces. One piece was placed in a chamber and exposed to acetonitrile fumes for 2 hours. Both films were exposed to 100 mW of light using a 532 nm laser for 10 min. The samples were monitored in real time by UV-visible spectroscopy at 500 nm. FIG. 3 is a plot of absorbance with time (in seconds) of the dye. The figure illustrates the enhanced photo-induced reaction rate (measured as the decrease in absorbance with time) of the dye when exposed to acetonitrile. The dotted curve represents the absorbance of the dye not exposed to the solvent and the solid curve represents the absorbance of the dye which is exposed to the solvent. As seen from the figure, the dye that is exposed to the solvent decreases in absorbance much faster than the dye that is not exposed to the solvent upon irradiation at a wavelength of 532 nm that may correspond to the “write” wavelength of the medium. The dye 4-hydroxy-2′,4′-dinitrostilbene undergoes accelerated photo-bleaching reaction at the write wavelength on exposure to solvent to form an irreversible photo-product.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

1. A method for storing holographic data comprising:
providing a holographic storage medium comprising an optically transparent substrate, said optically transparent substrate comprising a photochemically active dye and a sensitizing solvent;
step (A) irradiating the optically transparent substrate with a holographic interference pattern, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing an optically readable datum corresponding to the volume element; and
step (B) removing at least a portion of the sensitizing solvent from the optically transparent substrate to stabilize the optically readable datum.

2. The method of claim 1, wherein the optically transparent substrate comprises a thermoplastic polymer, a thermosetting polymer, or a combination comprising at least one of the foregoing polymers.

3. The method of claim 1, wherein the optically transparent substrate comprises a polycarbonate.

4. The method of claim 1, wherein the optically transparent substrate has a thickness of greater than about 100 micrometers.

5. The method of claim 1, wherein the sensitizing solvent comprises ammonia, acetonitrile, alcohol, toluene, ether, acetone, methyl ethylketone, water, acetylacetone, or a mixture comprising one or more of the foregoing solvents.

6. The method of claim 1, wherein the photochemically active dye comprises at least one of a nitrostilbene, a nitrone, a diarylethene, or a fulgide.

7. The method of claim 1, wherein the optically transparent substrate comprises the photochemically active dye in an amount from about 0.1 weight percent to about 10 weight percent.

8. The method of claim 1, wherein the first wavelength is in a range from about 360 nanometers to about 1500 nanometers.

9. The method of claim 1, wherein the first wavelength is in a range from about 400 nanometers to about 650 nanometers.

10. The method of claim 1, wherein providing the optically transparent substrate comprising a photochemically active dye and a sensitizing solvent comprises exposing an optically transparent substrate comprising a photochemically active dye to the sensitizing solvent for a time period greater than about 1 minute.

11. A method for storing holographic data comprising:
providing a holographic storage medium comprising an optically transparent substrate, said optically transparent substrate comprising a photochemically active dye and a sensitizing solvent, wherein the photochemically active dye comprises a nitrostilbene, wherein the sensitizing solvent comprises acetonitrile;
step (A) irradiating the optically transparent substrate with a holographic interference pattern, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing an optically readable datum corresponding to the volume element; and
step (B) removing at least a portion of the sensitizing solvent from the optically transparent substrate to stabilize the optically readable datum.

12. The method of claim 11, wherein the optically transparent substrate comprises a thermoplastic polymer, a thermosetting polymer, or a combination comprising at least one of the foregoing polymers.

13. The method of claim 11, wherein the optically transparent substrate has a thickness of greater than about 100 micrometers.

14. The method of claim 11, wherein the optically transparent substrate comprises the photochemically active dye in an amount from about 0.1 weight percent to about 10 weight percent.

15. The method of claim 11, wherein the first wavelength is in a range from about 400 nanometers to about 650 nanometers.

16. A method for storing holographic data comprising:
providing a holographic storage medium comprising an optically transparent substrate, said optically transparent substrate comprising a photochemically active dye and a sensitizing solvent, wherein the photochemically active dye comprises 4-hydroxy-2′,4′-dinitrostilbene, wherein the dye is present in an amount from about 0.1 weight percent to about 10 weight percent, wherein the sensitizing solvent comprises acetonitrile;
step (A) irradiating the optically transparent substrate with a holographic interference pattern, wherein the pattern has a first wavelength and an intensity both sufficient to convert, within a volume element of the substrate, at least some of the photochemically active dye into a photo-product, and producing within the irradiated volume element concentration variations of the photo-product corresponding to the holographic interference pattern, thereby producing an optically readable datum corresponding to the volume element, wherein the first wavelength is about 532 nm; and
step (B) removing at least a portion of the sensitizing solvent from the optically transparent substrate to stabilize the optically readable datum.

17. A holographic storage medium according to the method of claim 1, wherein the data storage medium comprises an optically transparent substrate, said optically transparent substrate comprising a photochemically active dye and a sensitizing solvent, wherein the photochemically active dye is present in an amount corresponding to about 0.1 weight percent to about 10 weight percent of the optically transparent substrate.

18. The holographic storage medium of claim 17, further comprising an optically readable datum, wherein the optically readable datum is stored as a hologram patterned within at least one volume element of the optically transparent substrate.

19. The holographic storage medium of claim 17, wherein the optically transparent substrate comprises polycarbonate.

20. The holographic storage medium of claim 17, wherein the sensitizing solvent comprises acetonitrile.
